(19) United States
(12) Patent Application Publication
(10) Pub. No.: US 2023/0069892 A1
(43) Pub. Date: Mar. 9, 2023

(54) SECURE EXPONENTIAL FUNCTION COMPUTATION SYSTEM, SECURE EXPONENTIAL FUNCTION COMPUTATION METHOD, SECURE COMPUTATION APPARATUS, AND PROGRAM

(71) Applicant: NIPPON TELEGRAPH AND TELEPHONE CORPORATION, Tokyo (JP)

(72) Inventor: Dai IKARASHI, Musashino-shi, Tokyo (JP)

(73) Assignee: NIPPON TELEGRAPH AND TELEPHONE CORPORATION, Tokyo (JP)

(21) Appl. No.: 17/790,534

(22) PCT Filed: Jan. 20, 2020
(86) PCT No.: PCT/JP2020/001676

§ 371 Date: Jul. 1, 2022

(51) Int. Cl. G06F 21/62

(52) U.S. Cl. CPC G06F 21/6218

(57) ABSTRACT

In secure computation, an exponential function is calculated at high speed. A secure exponential function computation system (100) receives [a] as an input and calculates [exp (a)]. The minimum value subtraction unit (11) calculates [a′]:=[a]−μ. A bit decomposition unit (12) generates a bit representation [a′₀], . . . , [a′ᵤ₋₁] of u upper bits of a′ from [a′]. A selective product unit (13) calculates a total product [f′] of values that are [a′ᵢ?fᵢ:1]. An upper bit calculation unit (14) calculates a total product [ε′] of [a′ᵢ?2^{ε_i}:1] for 0≤i<u. A lower bit calculation unit (15) calculates [a′_{ρ}]:=[a′]−Σ2^{i-t}[a′ᵢ]. An exponential function calculation unit (16) calculates [w]:=[exp (a′_{ρ})]. A result calculation unit (17) calculates [w][f′][ε′]exp (μ).

### TECHNICAL FIELD

The present invention relates to a technology for computing an exponential function in secure computation.

### BACKGROUND ART

Secure computation is a cryptographic technology for calculating any function while hiding data. A data utilization form is expected to be developed taking advantage of this feature so that data does not leak to either a system operator or a data user. There are several schemes for secure computation, and among them, the schemes including secret sharing as a component are known to have a small data processing unit and be able to perform high-speed processing.

Secret sharing is a method of converting secret information into several fragments called shares. For example, there is secret sharing called a (k, n) threshold method in which n shares are generated from the secret information and secrets can be restored from k or more shares, and thus, secret information is not leaked as long as the number of shares to restore the secret information is smaller than k. Shamir secret sharing, duplicate secret sharing, and the like are known as specific methods for configuring secret sharing. In the present specification, one fragment of a value shared by secret sharing is referred to as “share”. Further, an entire set of all shares is called a “share value”.

In recent years, research on advanced statistics or machine learning using secure computation has been actively performed. However, most of calculations thereof include calculations of an inverse, a square root, an exponent, a logarithm, and the like, going beyond calculations good for secure computation such as addition, subtraction, and multiplication. The calculation of the exponential function is one of basic operations on a computer or the like, and is used in various situations, NPL 1 discloses a method of calculating an exponential function in secure computation.

### CITATION LIST

### Non Patent Literature

NPL 1: Dai Ikarashi, “Secure Real Number Operations for Secure AI-O(|p|)-Bit Communication and O(1)—Round Right Shift Protocol—”, CSS2019, 2019

### SUMMARY OF THE INVENTION

### Technical Problem

However, a method disclosed in NPL 1 is computationally expensive.

An object of the present invention is to provide a secure computation technology capable of calculating an exponential function at high speed in view of the technical difficulty described above.

### Means for Solving the Problem

In order to solve the above problem, a secure exponential function computation system of one aspect of the present invention is a secure exponential function computation system for receiving a share value [a] of a value a as an input, and calculating a share value [exp (a)] of an output of an exponential function of the value a. The secure exponential function computation system includes a plurality of secure computation apparatuses. μ is an acquirable minimum value of the value a, t is a predetermined integer, and u is the number of bits more than t bits after a decimal point of the value a. Each of the plurality of secure computation apparatus includes a minimum value subtraction unit configured to obtain a share value [a′] of a value a′ obtained by subtracting the minimum value μ from the share value [a]; a bit decomposition unit configured to generate a sequence of share values [a′₀], . . . , [a′ᵤ₋₁] of a bit representation a′₀, . . . , a′ᵤ₋₁ of u upper bits of the value a′ from the share value [a′]; a selective product unit configured to set fᵢ as a mantissa part of exp (2^{i-t}) and calculate a share value [f′] of a value f′ obtained by multiplying all values that become fᵢ when a′ᵢ=1 and 1 when a′ᵢ=0 where i is an integer equal to or greater than 0 and smaller than u; an upper bit calculation unit configured to set εᵢ as an exponential part of exp (2^{i-t}) and calculate a share value [ε′] of a value ε′ obtained by multiplying all values that become 2^{ε_i} when a′ᵢ=1 and 1 when a′ᵢ=0 where i is an integer equal to or greater than 0 and smaller than u; a lower bit calculation unit configured to calculate a share value [a′ₚ] of a value a′_{ρ} obtained by subtracting a sum of values obtained by multiplying 2^{i-t} by the share value [a′ᵢ] from the share value [a′] where i is an integer equal to or greater than 0 and smaller than u; an exponential function calculation unit configured to use the share value [a′_{ρ}] to obtain a share value [w] obtained by calculating [exp (a′_{ρ})]; and a result calculation unit configured to calculate the share value [exp (a)] obtained by multiplying the share value [w], the share value [f′], the share value [ε′], and exp (μ).

### Effects of the Invention

According to the present invention, it is possible to compute an exponential function at high speed in secure computation.

### BRIEF DESCRIPTION OF DRAWINGS

FIG. 1 is a diagram illustrating a functional configuration of a secure exponential function computation system.

FIG. 2 is a diagram illustrating a functional configuration of a secure computation apparatus.

FIG. 3 is a diagram illustrating a functional configuration of a selective product unit.

FIG. 4 is a diagram illustrating a functional configuration of an exponential function calculation unit.

FIG. 5 is a diagram illustrating a processing procedure of a secure exponential function computation method.

FIG. 6 is a diagram illustrating a processing procedure of the selective product unit.

FIG. 7 is a diagram illustrating a processing procedure of the exponential function calculation unit.

FIG. 8 is a diagram illustrating a functional configuration of a computer.

### DESCRIPTION OF EMBODIMENTS

Hereinafter, embodiments of the present invention will be described in detail. In the drawings, components having the same function are denoted by the same numbers, and duplicate description thereof will be omitted.

In the present specification, the following notation is used.

[*] is data in which a numerical value is hidden. For example, share values of Shamir secret sharing, duplicate secret sharing, or the like can be used.

[a?b:c] represents b when a=1 and c when a=0.

[symbol]

, ¬,∧,∨,⊕ [Math. 1]

Symbols described above indicate a logical negation (NOT), a logical product (AND), a logical sum (OR), and an exclusive OR (XOR), respectively.

An integer in a ring can be regarded as a fixed-point real number by setting a public decimal point position for the integer. In the present invention, the fixed-point real number represented in the ring in this way is simply referred to as a real number.

The “_” (underscore) in the subscript indicates that a character on the left is subscripted with a character on the right. For example, “a^{b_c}” indicates that a is superscripted with be.

### Embodiment: Secure Exponential Function Computation System

An embodiment of the present invention is a secure exponential function computation system and method in which a share value [a] of a value a is an input and a share value [exp (a)] of an output of an exponential function of the value a is calculated with the value a hidden. Hereinafter, an overview of an exponential function protocol executed by the secure exponential function computation system of the embodiment will be described.

In the related art, in secure computation, a group of elementary functions such as an inverse, a square root, an exponential function, and a logarithm function that go beyond addition, subtraction, and multiplication has a high processing cost and has not been implemented. In order to solve these problems, the present invention enables an exponential function to be efficiently calculated using an algorithm that can efficiently and uniformly approximate the group of elementary functions in secure computation. With this approximation scheme, it is possible to approximate a major elementary function including an exponential function with a single scheme simply by changing parameters. Further, this approximation scheme is an amount of communication/the number of rounds for three real number multiplications in single precision (23 bits), which is a theoretically optimized efficiency.

The exponential function is an important function that is used as a component of a sigmoid function, a softmax function, or the like in various machine learning schemes such as logistic regression and deep learning, and also used in Fisher's exact test in statistics. Because the exponential function rapidly converges in the Taylor expansion, the exponential function is suitable to be calculated by the Taylor expansion.

$$exp ( x ) = {\sum }_{0 \leq i \to ω} \frac{{x}^{i}}{i !} = 1 + x + \frac{{x}^{2}}{2} + \frac{{x}^{3}}{6} + \frac{{x}^{4}}{24} … \qquad [ Math . 2 ]$$

However, because it is clear that convergence of the above equation is slow when x is great, the function cannot be applied in an input as it is. Because the exponential function is additive to an input, x may be additively decomposed as follows so that the following equation is calculated.

(1) Minimum value μ of assumed input

(2) u upper bits x₀, . . . , xᵤ₋₁ that are t or more bits after a decimal point of x−μ

(3) Number x_{ρ} indicated by all lower bits than x₀ of x−μ

expx=expμexp2^{-t}x₀ . . . exp2^{u-t-1}xᵤ₋₁expx_{ρ} [Math. 3]

Here, expμ is a public value. exp 2^{-t}x₀, . . . , exp 2^{u-t-1}xᵤ₋₁ are calculated from a binary table. exp x_{ρ} is a part to be calculated by approximation, and is normalized to [0, 2^{-t}) for efficient calculation. A value oft differs depending on a processing system, but because a processing cost of secure computation is high when a large table is referred to, the value should be set as small as possible. exp x_{ρ} can also be calculated by polynomial interpolation.

An algorithm for approximating a group of elementary functions in the secure computation with an eighth degree polynomial is shown hereinafter.

Algorithm 1: Function Approximation Protocol using Eighth Degree Polynomial Input: [x]∈[L, R)

### Parameters: a, b, c, d, f, g, H, i, j, k, l, m, n, o, p, q, α, β, γ, δ, and ζ

Output: [func (x)] corresponding to a target function func

1: Calculate [y′]:=[x(δx+a−i)−j] using a sum of products, and lower a decimal point position by right shift.

2: Calculate [y]:=[y′+(ix+j)].

3: Calculate [z′]:=[y(ζy+b−k)+(c−l)x−m] by sum of products, and lower the decimal point position by right shift.

4: Calculate [z]:=[z′+(ky+lx+m)].

5: Calculate [w′/y]:=[z(αz+d−n/γ)+(βx+f−o/γ) y+(g−p)x+(H−q)/γ] by sum of products, and perform multiplication by v and lowering a decimal point position at the same time to obtain [w′].

6: Output [w]:=[w′+(nz+oy+px+q)].

The lowering of the decimal point position executed in steps 1 and 3 of algorithm 1 can be efficiently performed by using, for example, a public divisor division disclosed in NPL 1.

Simultaneous execution of the public value multiplication and lowering of the decimal point executed in step 5 of algorithm 1 can be efficiently performed by using, for example, the following algorithm.

Algorithm 2: Multiplication of Public Value at Same Time without Increasing Processing Cost from Right Shift

Input: [x], multiplier m, shift amount σ
Output: [mx] after shift

1: Calculate a public value 2^{σ}/m.

2: Calculate the following equation through public value division. Here, [mx] is regarded as an expression the decimal point position of which is a lower than that of [x].

$$\frac{[ x ]}{\frac{{2}^{σ}}{m}} = [ mx ] \qquad [ Math . 4 ]$$

Parameters L, R, a, b, c, d, f, g, H, i, j, k, l, m, n, o, p, q, α, β, γ, δ, and ζ used in algorithm 1 are set according to the approximate function func. When an exponential function that is a target in the present invention is approximated, the respective parameters may be set as shown in the following table, for example.

Note that eₓ, e_{y}, e_{z}, and e_{w} are decimal point positions of x, y, z, and w, and e′_{y}, e′_{z}, and e′_{w} are decimal point positions of y′, z′, and w′. These are parameters that determine an amount of right shift in eighth degree polynomial approximation. For example, the amount of right shift when y is calculated from y′ is e′_{y}−e_{y}.

TABLE 1

| | | | |
|---|---|---|---|
| L | 0 | α | 3.875 |
| R | 2 | β | 0.4375 |
| a | 0.0150245363909133 | γ⁻¹ | 0.90198354150868 |
| b | 0.40985277532158 | δ | 2⁻³ |
| c | 0.218572247867126 | ζ | 2⁻² |
| d | 6.64826957208433 | eₓ | 28 |
| f | −0.737980772377752 | e_{y} | 29 |
| g | −0.580995576157224 | e_{z} | 29 |
| H | 1.00000000300262 | e_{w} | 27 |
| i | 0.5 | e’_{y} | 60 |
| j | −0.470402400605697 | e’_{z} | 61 |
| k | 1 | e’_{w} | 61 |
| l | 0 | | |
| m | 0 | | |
| n | 20 | | |
| o | 0 | | |
| p | −4 | | |
| q | −0.105107110464577 | | |

An algorithm for calculating an exponential function in secure computation using algorithm 1 is shown hereinafter.

Algorithm 3: Exponential Function Protocol

input: [a]
Output: [exp (a)]

### Parameter: t:=−1

1: Calculate [a′]:=[a]−μ.

2: Extract bits more than t bits after the decimal point through bit decomposition and perform mod p conversion to obtain [a′₀], . . . , [a′ᵤ₋₁].

3: Set fᵢ and εᵢ as a mantissa part and an exponential part of exp (2^{i-t}), with 0≤i<u.

4: Set [a′₀], . . . , [a′ᵤ₋₁] as conditions, set 1, f₀, 1, f₁, . . . , 1, and fᵤ₋₁ as options, and obtain a product [f′] by performing exponentiation by referencing a binary public table.

5: Calculate the following equation using an if-then-else gate of an option disclosure with each 0≤i<u.

[ε′ᵢ]:=if [a′ᵢ] then 2^{ε}^{ᵢ} else 1 [Math. 5]

6: Calculate a product [ε′] of [ε′ᵢ] regarding each i. This is a power of 2 of an exponent part of an upper bit part.

7: Calculate the following equation. This is a number indicated by a lower bit part.

$$[ {a}_{p}^{′} ] := [ {a}^{′} ] - {\sum }_{i < u} {2}^{i - t} [ {a}_{i}^{′} ] \qquad [ Math . 6 ]$$

8: Execute algorithm 1 for [a′_{ρ}] and calculate an exponential function of [a′_{ρ}]. A result is [w].

9: Calculate and output [w][f′][ε′]exp (μ). Algorithm 2 is used in calculation of exp (μ).

The exponentiation by referring to the binary public table executed in step 4 of algorithm 3 is processing of performing a plurality of operations for referencing and selecting a value from a binary table consisting of public values using a secret truth value, and multiplying respective reference results. The exponentiation by referring to the binary public table can be efficiently performed, for example, by using the following algorithm.

Algorithm 4: Exponentiation by Referring to Binary Public Table Input: Multiplier m_{0,0}, m_{0,1}, . . . , m_{n-1,0}, m_{n-1,1} and condition [c₀], . . . , [cₙ₋₁]

### Output:

$$[ {\prod }_{0 \leq i < n} ( {c}_{i} ? {m}_{i , 1} : {m}_{i , 0} ) ] \qquad [ Math . 7 ]$$

1: Set n₂ as a maximum even number equal to or smaller than n.

2: For each i∈{0, 2, . . . , n₂−2}

3: Calculate [cᵢcᵢ₋₁].

4: Set m′₀₀:=m_{i,0}m_{i=1,0}, m′₀₁:=m_{i,0}m_{i+1,1}, m′₁₀:=m_{i,1}m_{i+1,0}, m′₁₁:=m_{i,1}m_{i+1,1}.

5: Calculate [aᵢ]:=[cᵢcᵢ₊₁] (m₀₀+m₁₁−m₀₁−m₁₀)+[cᵢ] (m_{i+1,0}−m_{i,0})+[cᵢ₊₁](m_{i,1}−m_{i,0})+m_{i,0}.

6: Calculate the following equation in real number multiplication. Here, when n is an odd number, last right shift is not performed.

$$[ A ] := [ {\prod }_{i ∈ \{ 0 , 2 , … , {n}_{2} - 2 \}} {a}_{i} ] \qquad [ Math . 8 ]$$

7: Select remaining m_{n-1,0} and m_{n-1,1} using [cₙ₋₁] when n is an odd number, multiply [A] by m_{n-1,0} and m_{n-1,1}, and output a resultant value.

Selective public multiplication executed in step 7 of algorithm 4 can be efficiently performed by using, for example, the following algorithm.

Algorithm 5: Multiplication of Required Right Shift Value by Selective Public Multiplier

Input: [a], multipliers m₀ and m₁, condition [c]
Output: [m₁a] if c=1 and [m₀a] if c=0

1: Calculate [m₁a] and [m₀a].

2: Output [c?m₁a:m₀a] using an if-then-else gate.

The public value multiplication executed in step 1 of algorithm 5 can be efficiently performed, for example, by combining algorithm 2 with the following algorithm.

Algorithm 6: Right Shift in Plurality of Divisors/Public Divisor Division

Input: [a], divisor d₀, d₁, . . . , dₙ₋₁
Output: [a/d₀], [a/d₁], . . . , [a/dₙ₋₁]

1: Obtain a quotient [q] of [a].

2: Use the quotient [q] to calculate and output [a/dᵢ] for each i by right shift/public divisor division.

The quotient obtained in step 1 of algorithm 6 can be efficiently obtained through quotient transfer (see Reference 1).

Reference 1: Ryo Kikuchi, Dai Ikarashi, Takahiro Matsuda, Koki Hamada, and Koji Chida, “Efficient bit-decomposition and modulus-conversion protocols with an honest majority”, Proceedings of Information Security and Privacy—23rd Australasian Conference (ACISP 2018), pp. 64-82, Jul. 11-13, 2018.

Secure Exponential Function Computation System 100

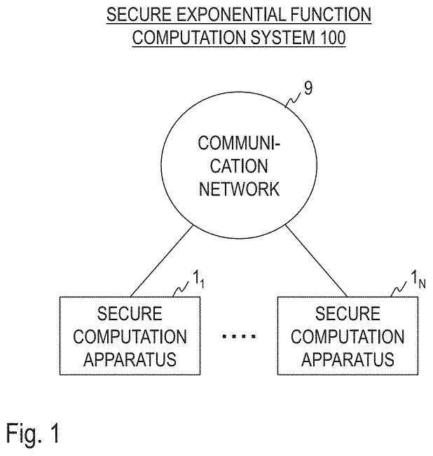

The secure exponential function computation system 100 of the embodiment is an information processing system that executes the above exponential function protocol. As illustrated in FIG. 1, the secure exponential function computation system 100 includes N (≥3) secure computation apparatuses 1₁, . . . , 1_{N}. In this embodiment, the secure computation apparatuses 1₁, . . . , 1_{N} are connected to a communication network 9. The communication network 9 is a circuit-switched or packet-switched communication network configured so that respective connected apparatuses can communicate with each other and, for example, the Internet, a local area network (LAN), a wide area network (WAN), or the like can be used. It is not necessary for each apparatus to be able to communicate online via the communication network 9. Each apparatus may be configured to store, for example, information to be input to a secure computation apparatus 1ₙ (n=1, . . . , N) in a portable recording medium such as a magnetic tape or a USB memory and input the information offline from the portable recording medium to the secure computation apparatus 1ₙ.

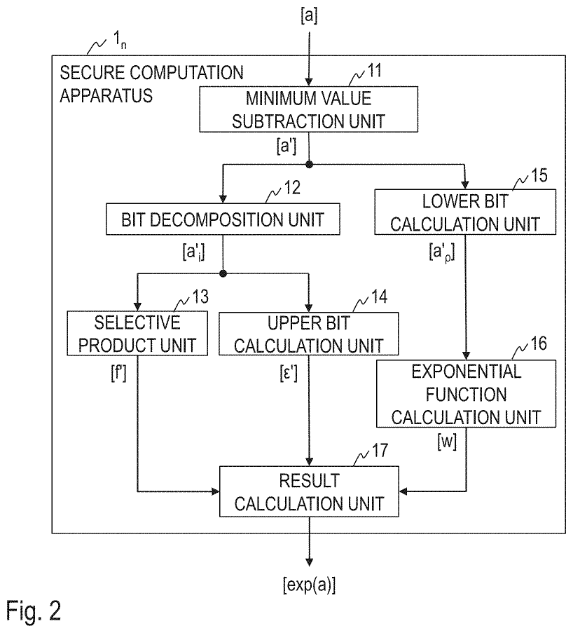

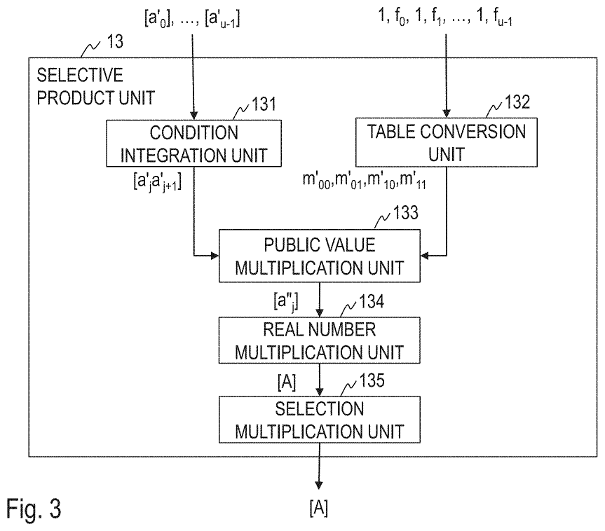

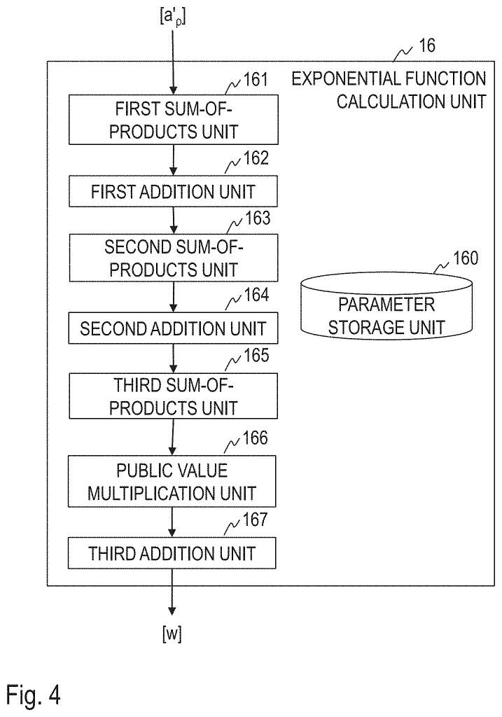

The secure computation apparatus 1ₙ included in the secure exponential function computation system 100 of the embodiment includes, for example, a minimum value subtraction unit 11, a bit decomposition unit 12, a selective product unit 13, an upper bit calculation unit 14, and a lower bit calculation unit 15, an exponential function calculation unit 16, and a result calculation unit 17, as illustrated in FIG. 2. The selective product unit 13 includes, for example, a condition integration unit 131, a table conversion unit 132, a public value multiplication unit 133, a real number multiplication unit 134, and a selection multiplication unit 135, as illustrated in FIG. 3. The exponential function calculation unit 16 includes, for example, a parameter storage unit 160, a first sum-of-products unit 161, a first addition unit 162, a second sum-of-products unit 163, a second addition unit 164, a third sum-of-products unit 165, a public value multiplication unit 166, and a third addition unit 167, as illustrated in FIG. 4.

The secure exponential function computation method according to the embodiment is realized by the secure computation apparatus 1ₙ performing processing of each step to be described below in cooperation with the other secure computation apparatus 1_{n′} (n′:=1, . . . , N, where n≠n′).

The secure computation apparatus 1ₙ is a special apparatus configured by loading a special program into a publicly known or dedicated computer including, for example, a central processing unit (CPU), a main storage device (RAM: Random Access Memory), and the like. The secure computation apparatus 1ₙ executes each process under the control of the central processing unit, for example. Data input to the secure computation apparatus 1ₙ or data obtained by each processing is stored in, for example, the main storage device, and the data stored in the main storage device is read to the central processing unit as needed, and used for other processing. At least a part of each processing unit of the secure computation apparatus 1ₙ may be configured by hardware such as an integrated circuit. Each storage unit included in the secure computation apparatus 1ₙ can be configured of, for example, a main storage device such as a random access memory (RAM), an auxiliary storage device configured of a hard disk, an optical disc, or a semiconductor memory element such as a flash memory, or middleware such as a relational database or a key value store.

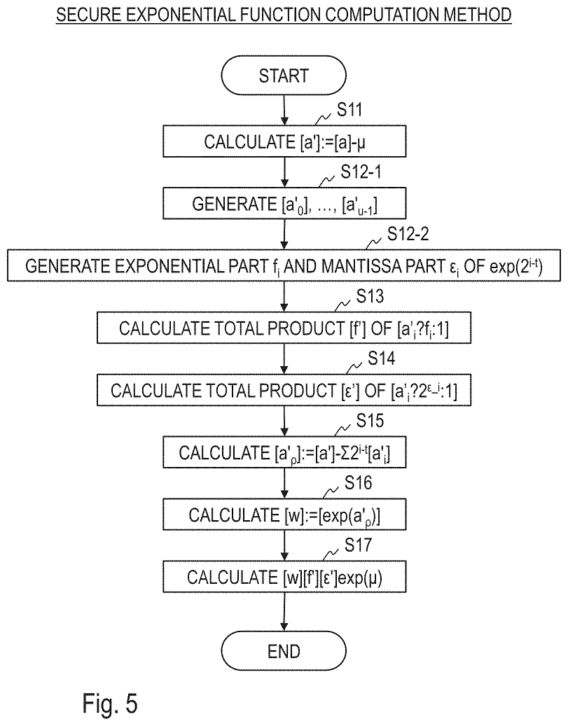

A processing procedure of the secure exponential function computation method executed by the secure exponential function computation system 100 of the embodiment will be described with reference to FIG. 5.

In step S11, the minimum value subtraction unit 11 of each secure computation apparatus 1ₙ subtracts an acquirable minimum value μ of the value a from the share value [a] of the value a input to the secure exponential function computation system 100 to obtain a share value [a′] of the value a′. That is, [a′]:=[a]−μ is calculated. The minimum value subtraction unit 11 outputs the share value [a′] to the bit decomposition unit 12 and the lower bit calculation unit 15.

In step S12-1, the bit decomposition unit 12 of each secure computation apparatus 1ₙ bit-decomposes bits more than t bits after the decimal point of the share value [a′] of the value a′ to obtain a sequence of share values {a′₀}, . . . , {a′ᵤ₋₁} of a bit representation a′₀, . . . , a′ᵤ₋₁ of u upper bits of a′. Next, the bit decomposition unit 12 performs mod p conversion on each of the share values {a′₀}, . . . , {a′ᵤ₋₁} to obtain a sequence of share values [a′₀], . . . , [a′ᵤ₋₁]. The bit decomposition unit 12 outputs the sequence of the share values [a′₀], . . . , [a′ᵤ₋₁] to the selective product unit 13 and the upper bit calculation unit 14. Further, in step S12-2, the bit decomposition unit 12 sets fᵢ and εᵢ as a mantissa part and an exponential part of exp (2^{i-t}) for each integer i equal to or greater than 0 and smaller than u.

In step S13, the selective product unit 13 of each secure computation apparatus 1ₙ calculates a share value [f′] of a value f′ obtained by multiplying all values that become fᵢ when a′ᵢ=1 and 1 when a′ᵢ=0 for each integer i equal to or greater than 0 and smaller than u. That is, algorithm 4 is executed with [a′₀], . . . , [a′ᵤ₋₁] as conditions and 1, f₀, 1, f₁, . . . , 1, fᵤ₋₁ as options to obtain the product [f′]. The selective product unit 13 outputs the share value [f′] to the result calculation unit 17.

In step S14, the upper bit calculation unit 14 of each secure computation apparatus 1ₙ calculates a share value [ε′] of a value ε′ obtained by multiplying all values that become 2^{ε_i} when a′ᵢ=1 and 1 when a′ᵢ=0 for each integer i equal to or greater than 0 and smaller than u. That is, in each 0≤i<u, [ε′ᵢ]:=if [a′ᵢ] then 2^{ε_i} else 1 is calculated by an if-then-else gate of an option disclosure and a product [ε′] obtained by multiplying [εᵢ]'s regarding each i is calculated. The upper bit calculation unit 14 outputs the share value [ε′] to the result calculation unit 17.

In step S15, the lower bit calculation unit 15 of each secure computation apparatus 1ₙ calculates a share value [a′_{ρ}] of a value a′_{ρ} obtained by subtracting a sum of values obtained by multiplying 2^{i-t} by [a′ᵢ] from the share value [a′] of the value a′ for each integer i equal to or greater than 0 and smaller than u. That is, the following equation is calculated. The lower bit calculation unit 15 outputs the share value [a′_{ρ}] to the result calculation unit 17.

$$[ {a}_{p}^{′} ] := [ {a}^{′} ] - {\sum }_{i < u} {2}^{i - t} [ {a}_{i}^{′} ] \qquad [ Math . 9 ]$$

In step S16, the exponential function calculation unit 16 of each secure computation apparatus 1ₙ uses parameters for approximating an exponential function with an eighth degree polynomial to execute algorithm 1, so that the exponential function is calculated for the share value [a′_{ρ}] of the value a′_{ρ}, and generates a share value [w] of a calculation result w. The exponential function calculation unit 16 outputs the share value [w] to the result calculation unit 17.

In step S17, the result calculation unit 17 of each secure computation apparatus 1ₙ multiplies the share value [w] of the calculation result w, the share value [f′] of the value f′, the share value [ε′] of the value ε′, and exp (μ), and outputs a share value [exp (a)] of an output of the exponential function of the value a.

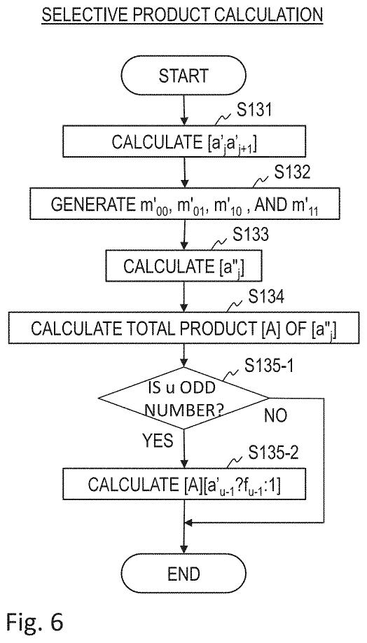

A processing procedure that is executed by the selective product unit 13 will be described in detail with reference to FIG. 6.

Hereinafter, n₂ is a maximum even number equal to or smaller than u. For each even number j equal to or greater than 0 and equal to or smaller than n₂−2, the following steps S131 to S133 are performed.

In step S131, the condition integration unit 131 of the selective product unit 13 calculates a share value [a′ⱼa′ⱼ₊₁] of a value a′ⱼa′ⱼ₊₁ obtained by multiplying a share value [a′ⱼ] of a value a′ⱼ by a share value [a′ⱼ₊₁] of a value a′ⱼ₊₁. The condition integration unit 131 outputs the share value [a′ⱼa′ⱼ₊₁] to the public value multiplication unit 133.

In step S132, the table conversion unit 132 of the selective product unit 13 sets m′₀₀:=1, m′₀₁:=fⱼ₊₁, m′₁₀:=fⱼ, and m′₁₁:=fⱼfⱼ₊₁ to generate a four-value table including m′₀₀, m′₀₁, m′₁₀, and m′₁₁. The table conversion unit 132 outputs the four-value table including m′₀₀, m′₀₁, m′₁₀, and m′₁₁ to the public value multiplication unit 133.

In step S133, the public value multiplication unit 133 of the selective product unit 13 calculates [a′ⱼa′ⱼ₊₁](m₀₀+m₁₁−m₀₁−m₁₀)+[a′ⱼ₊₁](fⱼ−1)+1. The public value multiplication unit 133 outputs the share value [a″ⱼ] to the real number multiplication unit 134.

In step S134, the real number multiplication unit 134 of the selective product unit 13 calculates a share value [A] of a value A multiplied by all the share values [a″ⱼ]. That is, the following equation is calculated. Because multiplication is real number multiplication, it is necessary for right shifting to be performed lastly, but when u is an odd number, the right shift is not performed herein.

$$[ A ] := [ {\prod }_{j ∈ \{ 0 , 2 , … , {n}_{2} - 2 \}} {a}_{j}^{″} ] \qquad [ Math . 10 ]$$

In step S135, if u is an odd number, the selection multiplication unit 135 of the selective product unit 13 multiplies the share value [A] of the value A by a value that becomes fᵤ₋₁ when a′ᵤ₋₁=1 and 1 when a′ᵤ₋₁=0, and outputs a resultant value. That is, [A][a′ᵤ₋₁?fᵤ₋₁:1] is calculated.

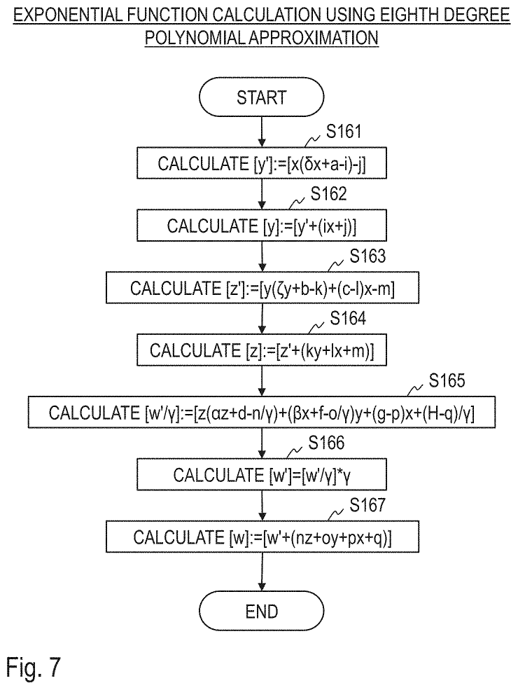

A processing procedure that is executed by the exponential function calculation unit 16 will be described in detail with reference to FIG. 7.

Parameters a, b, c, d, f, g, H, i, j, k, l, m, n, o, p, q, α, β, γ, δ, and ζ for approximating the exponential function with an eighth degree polynomial are stored in the parameter storage unit 160. Each parameter is determined in advance according to a function to be approximated, and when the exponential function is approximated, values shown in Table 1 may be set.

In step S161, the first sum-of-products unit 161 of the exponential function calculation unit 16 calculates [y′]:=[x(δx+a−i)−j] through a sum of products, and lowers the decimal point position through right shift. Here, x is a number a′_{ρ} indicating a lower bit part of the value a. That is, [x]:=[a′_{ρ}]. The first sum-of-products unit 161 outputs [y′] to the first addition unit 162.

In step S162, the first addition unit 162 of the exponential function calculation unit 16 calculates [y]:=[y′+(ix+j)].

The first addition unit 162 outputs [y] to the second sum-of-products unit 163.

In step S163, the second sum-of-products unit 163 of the exponential function calculation unit 16 calculates [z′]:=[y(ζy+b−k)+(c−l)x−m] through a sum of products, and lowers a decimal point position through right shift. The second sum-of-products unit 163 outputs [z′] to the second addition unit 164.

In step S164, the second addition unit 164 of the exponential function calculation unit 16 calculates [z]:=[z′+(ky+lx+m)]. The second addition unit 164 outputs [z] to the third sum-of-products unit 165.

In step S165, the third sum-of-products unit 165 of the exponential function calculation unit 16 calculates [w′/γ]:=[z(αz+d−n/γ)+(βx+f−o/γ)y+(g−p)x+(H−q)/γ] through a sum of products. The third sum-of-products unit 165 outputs [w′/γ] to the public value multiplication unit 166.

In step S166, the public value multiplication unit 166 of the exponential function calculation unit 16 calculates [w′]:=[w′/γ]*γ. The public value multiplication unit 166 outputs [w′] to the third addition unit 167.

In step S167, the third addition unit 167 of the exponential function calculation unit 16 calculates [w]:=[w′+(nz+oy+px+q)].

Although the embodiments of the present invention have been described above, a specific configuration is not limited to these embodiments, and even when a design is appropriately changed, for example, without departing from the spirit of the present invention, it is obvious that this is included in the present invention. Various processing described in the embodiments may be not only executed in chronological order according to order of description, but may also be executed in parallel or individually according to a processing capacity of an apparatus that executes processing or as necessary.

Program and Recording Medium

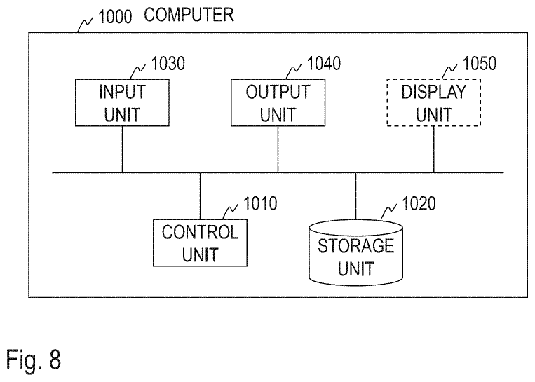

When various processing functions in each apparatus described in the above embodiment are realized by a computer, processing content of the function to be included in each apparatus is described by a program. This program is loaded into a storage unit 1020 of a computer illustrated in FIG. 8 and a control unit 1010, an input unit 1030, an output unit 1040, and the like are operated so that various processing functions in each of the above apparatuses are realized on the computer.

A program in which processing content thereof has been described can be recorded on a computer-readable recording medium. The computer-readable recording medium may be, for example, a magnetic recording device, an optical disc, a magneto-optical recording medium, or a semiconductor memory.

Further, distribution of this program is performed, for example, by selling, transferring, or renting a portable recording medium such as a DVD or CD-ROM on which the program has been recorded. Further, the program may be distributed by being stored in a storage device of a server computer and transferred from the server computer to another computer via a network.

The computer that executes such a program first temporarily stores, for example, the program recorded on the portable recording medium or the program transferred from the server computer in a storage device of the computer. When the computer executes the processing, the computer reads the program stored in the recording medium of the computer and executes processing according to the read program. Further, as another embodiment of the program, the computer may directly read the program from the portable recording medium and execute the processing according to the program, and further, processing according to a received program may be sequentially executed each time the program is transferred from the server computer to the computer. Further, a configuration may be adopted in which the above-described processing is executed by a so-called application service provider (ASP) type service for realizing a processing function according to only an execution instruction and result acquisition without transferring the program from the server computer to the computer. It is assumed that the program in the present embodiment includes information provided for processing of an electronic calculator and being pursuant to the program (such as data that is not a direct command to the computer, but has properties defining processing of the computer).

Further, in this embodiment, although the present apparatus is configured by a predetermined program being executed on the computer, at least a part of processing content of thereof may be realized by hardware.

1. A secure exponential function computation system for receiving a share value [a] of a value a as an input, and calculating a share value [exp (a)] of an output of an exponential function of the value a, the secure exponential function computation system comprising:
a plurality of secure computation apparatuses
wherein μ is an acquirable minimum value of the value a, t is a predetermined integer, and u is the number of bits more than t bits after a decimal point of the value a, and
each of the plurality of secure computation apparatuses comprises:
processing circuitry configured to:
obtain a share value [a′] of a value a′ obtained by subtracting the minimum value μ from the share value [a];
generate a sequence of share values [a′₀], . . . , [a′ᵤ₋₁] of a bit representation a′₀, . . . , a′ᵤ₋₁ of u upper bits of the value a′ from the share value [a′];
set fᵢ as a mantissa part of exp (2^{i-t}) and calculate a share value [f′] of a value f′ obtained by multiplying all values that become fᵢ when a′ᵢ=1 and 1 when a′ᵢ=0 where i is an integer equal to or greater than 0 and smaller than u;
set εᵢ as an exponential part of exp (2^{i-t}) and calculate a share value [ε′] of a value ε′ obtained by multiplying all values that become 2^{ε_i} when a′ᵢ=1 and 1 when a′ᵢ=0 where i is an integer equal to or greater than 0 and smaller than u;
calculate a share value [a′_{ρ}] of a value a′_{ρ} obtained by subtracting a sum of values obtained by multiplying 2^{i-t} by the share value [a′ᵢ] from the share value [a′] where i is an integer equal to or greater than 0 and smaller than u;
use the share value [a′_{ρ}] to obtain a share value [w] obtained by calculating [exp (a′_{ρ})]; and
calculate the share value [exp (a)] obtained by multiplying the share value [w], the share value [f′], the share value [ε′], and exp (μ).

2. The secure exponential function computation system according to claim 1,
wherein a, b, c, d, f, g, H, i, j, k, l, m, n, o, p, q, α, β, γ, δ, and ζ are parameters for approximating an exponential function with an eighth degree polynomial, and [x]:=[a′_{ρ}] is assumed, and
the processing circuitry further configured to:
calculate [y′]:=[x(δx+a−i)−j],
calculate [y]:=[y′+(ix+j)],
calculate [z′]:=[y(ζy+b−k)+(c−l)x−m],
calculate [z]:=[z′+(ky+lx+m)],
calculate [w′/γ]:=[z(αz+d−n/γ)+(βx+f−o/γ)y+(g−p)x+(H−q)/γ],
calculate [w′]:=[w/γ]*γ; and
calculate [w]:=[w′+(nz+op+px+q)].

3. The secure exponential function computation system according to claim L,
wherein the processing circuitry further configured to:
calculate a share value [a′ⱼa′ⱼ₊₁] obtained by multiplying the share value [a′ⱼ] by the share value [a′ⱼ₊₁] where j is an even number equal to or greater than 0 and smaller than u;
generate a four-value table including m′₀₀, m′₀₁, m′₁₀, and m′₁₁, where m′₀₀:=1, m′₀₁:=fⱼ₊₁, m′₁₀:=fⱼ, m′₁₁:=fⱼfⱼ₊₁, and j is an even number equal to or greater than 0 and smaller than u;
generate share values [a″ⱼ] of values a″ⱼ obtained by calculating [a′ⱼa′ⱼ₊₁](m₀₀+m₁₁−m₀₁−m₁₀)+[a′ⱼ₊₁](fⱼ−1)+1 where j is an even number equal to or greater than 0 and smaller than u;
calculate a share value [A] of a value A obtained by multiplying all the share values [a″ⱼ]; and
multiply, if u is an odd number, the share value [A] by a value that becomes fᵤ₋₁ when a′ᵤ₋₁=1 and 1 when a′ᵤ₋₁=0.

4. A secure exponential function computation method executed by a secure exponential function computation system including a plurality of secure computation apparatuses, having a share value [a] of a value a as an input, and calculating a share value [exp (a)] of an output of an exponential function of the value a,
the secure exponential function computation method comprising:
obtaining, by processing circuitry of each of the plurality of secure computation apparatus, a share value [a′] of a value a′ obtained by subtracting a minimum value μ from the share value [a];
generating, by the processing circuitry of the secure computation apparatus, a sequence of share values [a′₀], . . . , [a′ᵤ₋₁] of a bit representation a′₀, . . . , a′ᵤ₋₁ of u upper bits of the value a′ from the share value [a′];
setting, by the processing circuitry of the secure computation apparatus, fᵢ as a mantissa part of exp (2^{i-t}) and calculating a share value [f′] of a value f′ obtained by multiplying all values that become fᵢ when a′ᵢ=1 and 1 when a′₁=0 for each integer i equal to or greater than 0 and smaller than u;
setting, by the processing circuitry of the secure computation apparatus, εᵢ as an exponential part of exp (2^{i-t}) and calculating a share value [ε′] of a value ε′ obtained by multiplying all values that become 2^{ε_i} when a′ᵢ=1 and 1 when a′ᵢ=0 for each integer i equal to or greater than 0 and smaller than u;
calculating, by the processing circuitry of the secure computation apparatus, a share value [a′_{ρ}] of a value a′_{ρ} obtained by subtracting a sum of values obtained by multiplying 2^{i-t} by the share value [a′ᵢ] from the share value [a′] for each integer i equal to or greater than 0 and smaller than u;
using, by the processing circuitry of the secure computation apparatus, the share value [a′_{ρ}] to calculate a share value [w] obtained by calculating [exp (a′_{ρ})]; and
calculating, by the processing circuitry of the secure computation apparatus, the share value [exp (a)] obtained by multiplying the share value [w], the share value [f′], the share value [ε′], and exp (μ)
wherein μ is an acquirable minimum value of the value a, t is a predetermined integer, and u is the number of bits more than t bits after a decimal point of the value a.

5. The secure computation apparatus used in the secure exponential function computation system according to claim 1.

6. A non-transitory computer recording medium on which a program for causing a computer to operate as the secure computation apparatus according to claim 5.
